(19) United States
(12) Patent Application Publication
(10) Pub. No.: US 2024/0194212 A1
(43) Pub. Date: Jun. 13, 2024

(54) METHOD FOR END-TO-END SPEECH ENHANCEMENT BASED ON NEURAL NETWORK, COMPUTER-READABLE STORAGE MEDIUM, AND ELECTRONIC DEVICE

(71) Applicant: JINGDONG TECHNOLOGY HOLDING CO., LTD., Beijing (CN)

(72) Inventors: Zehua CHEN, Beijing (CN); Junyi WU, Beijing (CN); Yuyu CAI, Beijing (CN); Wei XUE, Beijing (CN); Fan YANG, Beijing (CN); Guohong DING, Beijing (CN); Xiaodong HE, Beijing (CN)

(73) Assignee: JINGDONG TECHNOLOGY HOLDING CO., LTD., Beijing (CN)

(21) Appl. No.: 18/553,221

(22) PCT Filed: Mar. 25, 2022
(86) PCT No.: PCT/CN2022/083112

§ 371 Date: Sep. 29, 2023

(30) Foreign Application Priority Data
Apr. 6, 2021 (CN) 202110367186.4

(51) Int. Cl. G10L 21/0224; G10L 25/30; G10L 25/45

(52) U.S. Cl. CPC G10L 21/0224; G10L 25/30; G10L 25/45

(57) ABSTRACT

A method for end-to-end speech enhancement based on a neural network, including: obtaining a time-domain smoothing feature of an original speech signal by performing feature extraction on the original speech signal using a time-domain convolution kernel; and, obtaining an enhanced speech signal by performing combined feature extraction on the original speech signal and the time-domain smoothing feature of the original speech signal.

### CROSS REFERENCE

The present application is a U.S. National Stage of International Application No. PCT/CN2022/083112, filed on Mar. 25, 2022, and claims priority to Chinese Patent Application No. 202110367186.4 entitled “Method and apparatus for end-to-end speech enhancement based on a neural network”, filed on Apr. 6, 2021, both the content of which is incorporated herein by reference in its entirety.

### TECHNICAL FIELD

The present disclosure relates to the field of speech signal processing, and in particular, to a method for end-to-end speech enhancement based on a neural network, an apparatus for speech enhancement, a computer-readable storage medium, and an electronic device.

### BACKGROUND

In recent years, with the high-speed development of the deep learning technology, the recognition effect of the speech recognition technology is greatly improved, and the speech recognition accuracy of the technology in a noise-free scene has reached a standard that manual speech recognition standard can be replaced.

It should be noted that the information disclosed in the above background part is only used to enhance the understanding of the background of the present disclosure, and therefore may include information that does not constitute related art known to those of ordinary skill in the art.

### SUMMARY

According to a first aspect of the present disclosure, there is provided a method for end-to-end speech enhancement based on a neural network, including:
obtaining a time-domain smoothing feature of an original speech signal by performing feature extraction on the original speech signal using a time-domain convolution kernel;
obtaining an enhanced speech signal by performing combined feature extraction on the original speech signal and the time-domain smoothing feature of the original speech signal.

In some embodiments of the present disclosure, obtaining a time-domain smoothing feature of an original speech signal by performing feature extraction on the original speech signal using a time-domain convolution kernel includes:
determining a time-domain smoothing parameter matrix according to a convolution sliding window and a time-domain smoothing factor;
obtaining a weight matrix of the time-domain convolution kernel by performing a product operation on the time-domain smoothing parameter matrix;
obtaining the time-domain smoothing feature of the original speech signal by performing a convolution operation on the weight matrix of the time-domain convolution kernel and the original speech signal.

In some embodiments of the present disclosure, determining a time-domain smoothing parameter matrix according to a convolution sliding window and a time-domain smoothing factor includes:
initializing a plurality of time-domain smoothing factors;
obtaining the time-domain smoothing parameter matrix based on a preset convolution sliding window and the plurality of time-domain smoothing factors.

In some embodiments of the present disclosure, obtaining an enhanced speech signal by performing combined feature extraction on the original speech signal and the time-domain smoothing feature of the original speech signal includes:
obtaining a speech signal to be enhanced by combining the original speech signal and the time-domain smoothing feature of the original speech signal;
training a weight matrix of the time-domain convolution kernel by using a back propagation algorithm with the speech signal to be enhanced as an input of a deep neural network,
obtaining the enhanced speech signal by performing combined feature extraction on the speech signal to be enhanced according to the weight matrix obtained by training.

In some embodiments of the present disclosure, training a weight matrix of the time-domain convolution kernel by using a back propagation algorithm with the speech signal to be enhanced as an input of a deep neural network includes:
inputting the speech signal to be enhanced into the deep neural network, and constructing a time-domain loss function;
training the weight matrix of the time-domain convolution kernel by using an error back propagation algorithm according to the time-domain loss function.

In some embodiments of the present disclosure, obtaining the enhanced speech signal by performing combined feature extraction on the speech signal to be enhanced according to the weight matrix obtained by training includes:
obtaining a first time-domain feature map by performing a convolution operation on the weight matrix obtained by training and an original speech signal in the speech signal to be enhanced;
obtaining a second time-domain feature map by performing a convolution operation on the weight matrix obtained by training and a smoothing feature in the speech signal to be enhanced;
obtaining the enhanced speech signal by combining the first time-domain feature map and the second time-domain feature map.

According to a second aspect of the present disclosure, there is provided a computer-readable storage medium, where a computer program is stored on the computer-readable storage medium, and when the computer program is executed by a processor, the method according to any one of the above is implemented.

According to a third aspect of the present disclosure, there is provided an electronic device, including: a processor; and a memory, configured to store an executable instruction of the processor; where the processor is configured to execute the method according to any one of the above by executing the executable instruction.

It should be understood that the above general description and the following detailed description are exemplary and explanatory only and are not intended to limit the present disclosure.

### BRIEF DESCRIPTION OF THE DRAWINGS

The accompanying drawings, which are incorporated in and constitute a part of the description, illustrate embodiments consistent with the disclosure and together with the description serve to explain the principles of the disclosure. Obviously, the drawings in the following description are some embodiments of the present disclosure, and for those of ordinary skill in the art, other drawings can also be obtained from these drawings without creative efforts.

FIG. 1 shows a schematic diagram of an exemplary system architecture of a method and an apparatus for end-to-end speech enhancement according to some embodiments of the present disclosure;

FIG. 2 shows a schematic structural diagram of a computer system suitable for implementing an electronic device according to some embodiments of the present disclosure;

FIG. 3 schematically shows a flowchart of a method for end-to-end speech enhancement according to some embodiments of the present disclosure;

FIG. 4 schematically shows a flowchart of time-domain smoothing feature extraction according to some embodiments of the present disclosure;

FIG. 5 schematically shows a flowchart of obtaining an enhanced speech signal according to some embodiments of the present disclosure;

FIG. 6 schematically shows a flowchart of combined feature extraction according to some embodiments of the present disclosure;

FIG. 7 schematically shows a flowchart of a method for end-to-end speech enhancement according to some embodiments of the present disclosure;

FIG. 8 schematically shows a block diagram of an apparatus for end-to-end speech enhancement according to some embodiments of the present disclosure.

### DETAILED DESCRIPTION

Example embodiments will now be described more fully with reference to the accompanying drawings. Example embodiments, however, can be implemented in various forms and should not be construed as limited to the embodiments set forth herein; by contrast, these embodiments are provided so that the present disclosure will be thorough and complete, and will fully convey the concept of example embodiments to those skilled in the art. The described features, structures, or characteristics may be combined into one or more embodiments in any suitable manner. In the following description, numerous specific details are provided to give a thorough understanding of embodiments of the present disclosure. However, those skilled in the art will realize that the technical solution of the present disclosure can be practiced while omitting one or more specific details, or employing other methods, components, devices, steps, etc. In other cases, commonly known technical solutions are not shown or described in detail, so as to avoid blurring various aspects of the present disclosure due to a reversal of the order of host and guest.

In addition, the drawings are merely schematic diagrams of the present disclosure, and the same reference numerals in the drawings represent the same or similar parts, and thus the repeated description of them will be omitted. Some block diagrams shown in the drawings are functional entities, and do not necessarily correspond to physical or logically independent entities. These functional entities may be implemented in the form of software, or these functional entities may be implemented in one or more hardware modules or integrated circuits, or these functional entities may be implemented in different networks and/or processor devices and/or microcontroller devices.

At present, the speech recognition technology can be mainly applied to scenes such as intelligent customer service, conference recording and transliterating, and intelligent hardware. However, when there is noise in the background environment, for example, noise in the surrounding environment of the user during an intelligent customer service call or background noise in the conference record audio, affected by such noise, the speech recognition technology may not accurately recognize the semantics of the speaker, thus affecting the overall accuracy of speech recognition.

Therefore, how to improve the accuracy of speech recognition in the case of noise becomes a difficulty that needs to be overcome in the speech recognition technology.

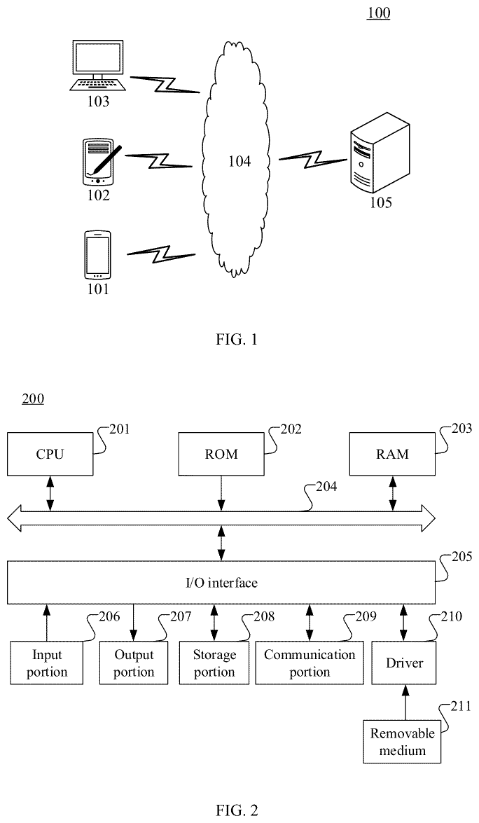

FIG. 1 shows a schematic diagram of an exemplary system architecture of an application environment of a method and an apparatus for end-to-end speech enhancement according to some embodiments of the present disclosure.

As shown in FIG. 1, the system architecture 100 may include one or more of the terminal devices 101, 102, 103, a network 104 and a server 105. The network 104 is configured to provide medium for communication links between the terminal devices 101, 102, 103 and server 105. The network 104 may include various connection types, such as wired, wireless communication links, or fiber optic cables, and the like. The terminal devices 101, 102, 103 may be various electronic devices having a display screen, including but not limited to a desktop computer, a portable computer, a smartphone, a tablet computer, and the like. It should be understood that the number of terminal devices, networks, and servers in FIG. 1 is merely illustrative. According to implementation requirements, there may be any number of terminal devices, networks, and servers. For example, the server 105 may be a server cluster composed of a plurality of servers.

The method for end-to-end speech enhancement provided in the embodiments of the present disclosure is generally performed by the server 105, and correspondingly, the apparatus for end-to-end speech enhancement is generally disposed in the server 105. However, it would be easy for those skilled in the art to understand that the method for end-to-end speech enhancement provided in the embodiments of the present disclosure may also be performed by the terminal devices 101, 102, 103, and correspondingly, the apparatus for end-to-end speech enhancement may also be disposed in the terminal devices 101, 102, 103, which is not specifically limited in the present exemplary embodiments.

FIG. 2 shows a schematic structural diagram of a computer system suitable for implementing an electronic device according to some embodiments of the present disclosure.

It should be noted that the computer system 200 of the electronic device shown in FIG. 2 is merely an example, and should not bring any limitation to the functions and use ranges of the embodiments of the present disclosure.

As shown in FIG. 2, the computer system 200 includes a central processing unit (CPU) 201 that can perform various appropriate actions and processes according to a program stored in a read-only memory (ROM) 202 or a program loaded into a random access memory (RAM) 203 from a storage portion 208. In the RAM 203, various programs and data required for system operation are also stored. The CPU 201, the ROM 202, and the RAM 203 are connected to each other through a bus 204. An input/output (I/O) interface 205 is also connected to the bus 204.

The following components are connected to the I/O interface 205: an input portion 206 including a keyboard, a mouse, or the like; an output portion 207 including a cathode ray tube (CRT), a liquid crystal display (LCD), a speaker, or the like; a storage portion 208 including a hard disk or the like; and, a communication portion 209 including a network interface card such as a LAN card, a modem, or the like. The communication portion 209 performs communication processing via a network such as the Internet. The driver 210 is also connected to the I/O interface 205 as needed. The removable medium 211, such as a magnetic disk, an optical disk, a magneto-optical disk, a semiconductor memory, or the like, is mounted on the driver 210 as needed so that the computer program read therefrom is installed into the storage portion 208 as needed.

In particular, the processes described below with reference to the flowchart may be implemented as a computer software program in accordance with embodiments of the present disclosure. For example, embodiments of the present disclosure include a computer program product including a computer program carried on a computer-readable medium, the computer program including program code for performing the method shown in the flowchart. In such embodiments, the computer program may be downloaded from the network through the communication portion 209 and installed, and/or installed from the removable medium 211. When the computer program is executed by the central processing unit (CPU) 201, various functions defined in the method and apparatus of the present disclosure are performed.

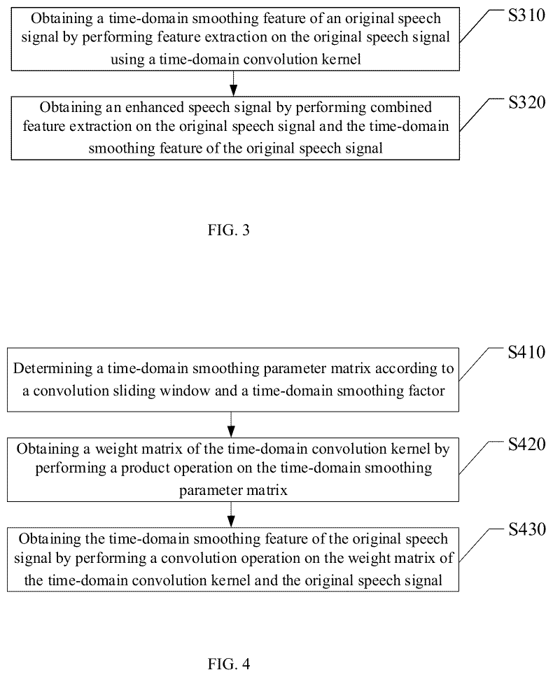

As another aspect, the present disclosure further provides a computer-readable medium, and the computer-readable medium may be included in the electronic device described in the foregoing embodiments; or, the computer-readable medium may exist alone, but is not assembled into the electronic device. The computer-readable medium carries one or more programs, and when the one or more programs are executed by an electronic device, the electronic device is enabled to implement the method described in the following embodiments. For example, the electronic device may implement various steps, or the like, as shown in FIG. 3 to FIG. 7.

It should be noted that the computer-readable medium shown in the present disclosure may be a computer-readable signal medium or a computer-readable storage medium, or any combination of the above. The computer-readable storage medium may be, for example, but is not limited to, an electrical, magnetic, optical, electromagnetic, infrared, or semiconductor system, apparatus, or device, or any combination of the above. More specific examples of computer-readable storage medium may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium that includes or stores a program that may be used by or in connection with an instruction execution system, apparatus, or device. In the present disclosure, a computer-readable signal medium may include data signals propagated in a baseband or as part of a carrier, where a computer-readable program code is carried. Such propagated data signals may take a variety of forms, including, but not limited to, electromagnetic signals, optical signals, or any suitable combination of above. The computer-readable signal medium may also be any computer-readable medium other than a computer-readable storage medium, which may send, propagate, or transmit a program for use by or in connection with an instruction execution system, apparatus, or device. The program code included on the computer-readable medium may be transmitted with any suitable medium, including but not limited to: wireless, wire, optical cable, RF, etc., or any suitable combination of the above.

The technical solutions of the embodiments of the present disclosure are described in detail below.

In the time domain, the actually observed speech signal may be represented as a sum of a pure speech signal and a noise signal, i.e.:

y(n)=x(n)+w(n),
where, y(n) represents a time-domain speech signal with a noise, x(n) represents a time-domain pure speech signal, w(n) represents a time-domain noise signal.

When performing enhancement processing on the speech signal, the speech signal with a noise can be changed from a one-dimensional time-domain signal to a complex-domain two-dimensional variable Y(k,l) through a short-time Fourier transform (STFT), and amplitude information of the variable can be taken, which corresponds to the following:

|Y(k,l)|=|X(k,l)|+|W(k,l)|,
where, |Y(k,l)| represents the amplitude information of the complex-domain speech signal, |X(k,l)| represents the amplitude information of the complex-domain pure speech signal, |W (k,l)| represents the amplitude information of the complex-domain noise signal, k represents the kth frequency grid on the frequency axis, and l represents the lth time frame on the time axis.

In some embodiments, noise reduction of the speech signal may be implemented by solving a gain function G(k,l). Among them, the gain function may be set as a time-varying and frequency-dependent function, and the STFT parameter X(k,l) of the predicted pure speech signal \hat{x}(n) may be obtained through the gain function and the speech signal with a noise Y(k,l), i.e.:

\hat{X}(k,l)=G(k,l)×|Y(k,l)|.

The pure speech signal \hat{X}(k,l) may also be estimated by obtaining f_{θ}(Y(k,l)) through training a deep neural network, i.e.:

\hat{X}(k,l)=f_{θ}(|Y(k,l)|).

In the above for method speech enhancement, when the pure speech signal x(n) is predicted according to the amplitude information in the speech signal with a noise Y(k,l), the phase information of Y(k,l) is not enhanced. If the phase information is not enhanced, when the signal-to-noise ratio of Y(k,l) is high, the difference between \hat{x}(n) recovered according to the phase information of Y(k,l) as well as the predicted \hat{X}(k,l) and actual pure speech signal x(n) is not significant. However, when the signal-to-noise ratio of Y(k,l) is low, and if the signal-to-noise ratio is 0 db or less, if only the amplitude information is enhanced and the phase information is ignored, the difference between the finally recovered x(n) and actual pure speech signal x(n) will be significant, resulting in a poor overall speech enhancement effect.

Based on one or more of the above problems, there is provided a method for end-to-end speech enhancement based on a neural network according to the present exemplary embodiment. The method may be applied to the server 105, or may be applied to one or more of the terminal devices 101, 102, and 103, which is not specifically limited in the present exemplary embodiment. Referring to FIG. 3, the method for end-to-end speech enhancement may include the following steps S310 and S320.

In step S310, a time-domain smoothing feature of the original speech signal is obtained by performing feature extraction on the original speech signal using a time-domain convolution kernel.

In step S320, an enhanced speech signal is obtained by performing combined feature extraction on the original speech signal and the time-domain smoothing feature of the original speech signal.

In the method for speech enhancement provided by the embodiment of the present disclosure, a time-domain smoothing feature of the original speech signal is obtained by performing feature extraction on the original speech signal using the time-domain convolution kernel; and, an enhanced speech signal is obtained by performing combined feature extraction on the original speech signal and the time-domain smoothing feature of the original speech signal. On one hand, by performing enhancement on both the amplitude information and the phase information in the original speech signal, the overall effect of speech enhancement can be improved; on the other hand, the time-domain smoothing feature extraction is performed on the original speech signal through the convolutional neural network, self-learning of the time-domain noise reduction parameter can be realized in combination with the deep neural network, and the quality of the speech signal can be further improved.

The above steps in the embodiments of the present example are described in more detail.

In step S310, a time-domain smoothing feature of the original speech signal is obtained by performing feature extraction on the original speech signal using a time-domain convolution kernel.

End-to-end speech enhancement may directly process the original speech signal, avoiding extracting acoustic features through intermediate transformation. The interference of the environmental noise in the speech communication process is inevitable, and the actually observed original speech signal is generally a speech signal with a noise in the time domain. Before performing feature extraction on the original speech signal, the original speech signal may be obtained firstly.

The original speech signal is a continuously changing analog signal, and the analog sound signal can be converted into a discrete digital signal by sampling, quantizing and encoding. For example, a value of an analog quantity of the analog signal may be measured at a certain frequency every other period of time, a point obtained by sampling may be quantized, and the quantized value may be represented by a set of binary values. Therefore, the obtained original speech signal may be represented by a one-dimensional vector.

In some embodiments, the original speech signal may be input into a deep neural network for time-varying feature extraction. For example, based on the correlation between adjacent frames of the speech signal, the local feature of the original speech signal may be calculated by performing smoothing processing in a time dimension, where speech enhancement may be performed on both the phase information and the amplitude information in the original speech signal.

Noise reduction processing can be performed on the original speech signal in the time domain, and the accuracy of speech recognition can be improved by enhancing the original speech signal. For example, speech enhancement may be performed by using a deep neural network model; when noise reduction processing is performed on the time-domain speech signal through a smoothing algorithm, the smoothing algorithm may be incorporated into a convolution module of the deep neural network; a multi-layer filter may be used in the convolution module to implement extraction of different features, and then different features may be combined into new different features.

For example, a time-domain smoothing algorithm may be incorporated into the deep neural network as a one-dimensional convolution module, and the one-dimensional convolution module may be a TRAL (Time-Domain Recursive Averaging Layer) module, corresponding to the noise smoothing in the time axis dimension. The original speech signal may be used as the input of the TRAL module, and the original speech signal may be filtered through the TRAL module, that is to perform noise smoothing in the time axis dimension. For example, the amplitude spectrum information of each time point on the time axis to be smoothed may be predicted by using a weighted moving average method, where the weighted moving average method may predict the future value according to the influence degree (corresponding to different weights) of the data at different times in a same moving section on the predicted value.

Referring to FIG. 4, noise smoothing may be performed on the time-domain speech signal according to steps S410 to S430.

In step S410, a time-domain smoothing parameter matrix is determined according to a convolution sliding window and a time-domain smoothing factor.

In some embodiments, the TRAL module may perform processing on the original input information by using a plurality of time-domain smoothing factors. In some embodiments, the smoothing on the time-domain speech signal by the TRAL module may be implemented through a sliding window, and the corresponding smoothing algorithm may be as follows:

R(n)=Σᵢ₌₁^{D}α^{D-i}(1−α)y(n),α=[α₀ . . . α_{N}],
where, n represents a sampling point of the original speech signal;
D represents a width of the sliding window, which may be set according to actual situations. In this example, it is preferable that the width of the sliding window may be set to 32 frames;
α is a time-domain smoothing factor, representing the utilization degree of the speech signal y(n) of each sampling point within the width of the sliding window when smoothing processing is performed on the time-domain speech signal; [α₀ . . . α_{N}] is different smoothing factors; the value range of each smoothing factor is [0, 1]; corresponding to the value of α, the number of convolution kernels in the TRAL module may be N;
y(n) represents a speech signal of each sampling point within the width of the sliding window. In this example, the speech signal of each sampling point may be utilized. For example, the speech signal of the 32th frame of sampling points may be composed of the speech signal of the previous 31 frame of sampling points within the width of the sliding window.

In addition, there is i∈[1, D]. When the farther a certain sampling point away from the current sampling point, the smaller the value of α^{D-i}, the smaller the weight of the speech signal of the sampling point; when the closer to the speech signal of the sampling point, the greater the value of α^{D-i}, the greater the weight of the speech signal of the sampling point;

R(n) represents a new speech signal obtained by superimposing the speech signal of each historical sampling point within the width of the sliding window, which is also a speech signal obtained through smoothing in the time domain.

It can be understood that in the TRAL module, the time-domain smoothing parameter matrix may be determined according to the convolution sliding window and the time-domain smoothing factor, that is, the first time-domain smoothing parameter matrix [α⁰ . . . α^{D-i}] and the second time-domain smoothing parameter matrix [1−α] may be determined according to the sliding window width D and the time-domain smoothing factor α=[α₀ . . . α_{N}].

In step S420, a weight matrix of the time-domain convolution kernel is obtained by performing a product operation on the time-domain smoothing parameter matrix.

Before performing time-domain feature extraction on the original speech signal, firstly, the weight matrix of the time-domain convolution kernel may be determined. For example, a plurality of time-domain smoothing factors α may be initialized, such as α=[α₀ . . . α_{N}], and a time-domain smoothing parameter matrix may be obtained based on a preset convolution sliding window and a plurality of time-domain smoothing factors. In some embodiments, when performing smoothing on the time axis, there may be N convolution kernels correspondingly in the TRAL module, and each convolution kernel corresponds to a different smoothing factor. Among them, the first time-domain smoothing parameter matrix corresponding to each convolution kernel may be [α⁰ . . . α^{D-i}]; by combining the first time-domain smoothing parameter matrix with the second time-domain smoothing parameter matrix [1−α], for example, by performing a product operation on the first time-domain smoothing parameter matrix and the second time-domain smoothing parameter matrix, a final weight matrix N(α) of the time-domain convolution kernel may be obtained.

In step S430, a time-domain smoothing feature of the original speech signal is obtained by performing a convolution operation on the weight matrix of the time-domain convolution kernel and the original speech signal.

The original speech signal may be used as an original input. The original speech signal may be a 1*N one-dimensional vector, and a time-domain smoothing feature of the original speech signal may be obtained by performing a convolution operation on the one-dimensional vector and the weight matrix N(α) of the time-domain convolution kernel. In this example, the noise reduction algorithm is made into a convolution kernel by using the concept of convolution kernel in the convolutional neural network, and noise reduction of the time-varying speech signal is realized in the neural network through the combination of a plurality of convolution kernels. Moreover, by performing smoothing on the speech signal with a noise in the time domain, the signal-to-noise ratio of the original input information may be improved, where the input information may include the amplitude information and the phase information of the speech signal with a noise.

In step S320, an enhanced speech signal is obtained by performing combined feature extraction on the original speech signal and the time-domain smoothing feature of the original speech signal.

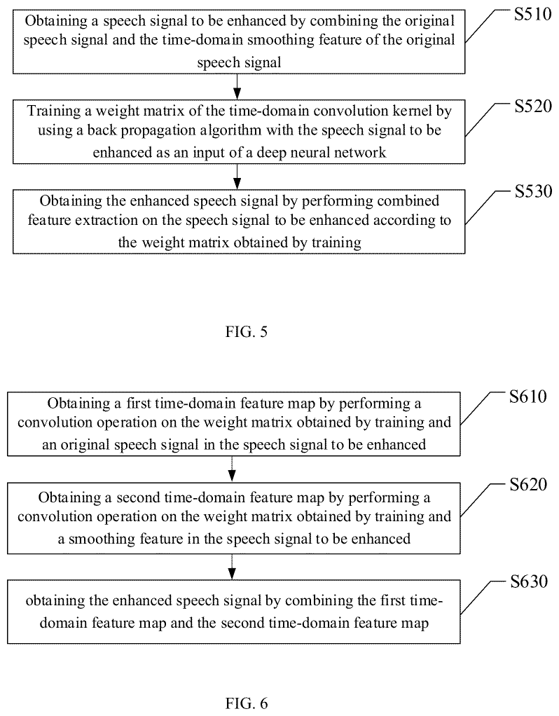

Referring to FIG. 5, an enhanced speech signal may be obtained according to steps S510 to S530.

In step S510, a speech signal to be enhanced is obtained by combining the original speech signal and the time-domain smoothing feature of the original speech signal.

In some embodiments, in order to better preserve the speech feature of the original input, the original input feature and the output of the TRAL module can be spliced, so that the features of the original speech signal can be preserved, and deep level features can be learned.

Correspondingly, the input of the deep neural network may be changed from the original input y(n) to a combined input, and the combined input may be as follows:

$${I}_{i} ( n ) = \{ \begin{matrix}y ( n ) , i = 1 \\ R ( n ) , otherwise\end{matrix} ,$$

where, Iᵢ(n) is the speech signal to be enhanced obtained by combining; y(n) is the original input speech signal with a noise; and, R(n) is the output of the TRAL module, that is, the speech signal smoothed along the time axis.

In this example, the smoothing factor of a filter in the TRAL module is 0, that is, smoothing processing is not performed on the original information, and the original input is maintained. Other filters can implement different smoothing processing on the original information through different smoothing factors, thus not only maintaining the input of the original information, but also increasing the input information of the deep neural network. Moreover, the TRAL module has the interpretability of the noise reduction algorithm developed by expert knowledge and the powerful fitting capability formed after being incorporated in to the neural network, is an interpretable neural network module, and can effectively combine the advanced signal processing algorithm in the field of speech noise reduction with the deep neural network.

In step S520, the weight matrix of the time-domain convolution kernel is trained by using a back propagation algorithm with the speech signal to be enhanced as an input of a deep neural network.

The speech signal to be enhanced may be input into the deep neural network, and a time-domain loss function, such as a mean square error loss function, may be constructed. Based on the deep neural network, the speech enhancement task in the time-domain may be expressed as follows:

\hat{x}(n)=f_{θ}(Iᵢ(n)).

In some embodiments, a U-Net convolutional neural network model with an encoder-decoder structure may be constructed as an end-to-end speech enhancement model, and the TRAL module may be incorporated into the neural network model. The U-net convolutional neural network model may include a full convolution portion (Encoder layer) and a deconvolution portion (Decoder layer). Among them, the full convolution portion can be used for performing feature extraction to obtain a low-resolution feature map, which is equivalent to a filter in the time domain, can encode the input information, and can also encode the output information of an upper Encoder layer again to realize the extraction of the high-level features. The deconvolution portion can obtain the feature map of the same size as the original size by up-sampling the feature map of a small size, that is, the information encoded by the Encoder layer may be decoded. In addition, a jump connection may be performed between the Encoder layer and the Decoder layer to enhance the decoding effect.

In some embodiments, based on the following:

f_{θ}(Iᵢ(n))=g^{L}(w^{L}g^{L-1}( . . . g¹(w¹*Iᵢ(n)))),
the enhanced speech signal may be calculated. Among them, Iᵢ(n) is the final input information in the U-Net convolutional neural network, that is, the combined speech signal to be enhanced; w^{L} may represent the weight matrix of the Lth layer in the U-Net convolutional neural network; g^{L} may represent the nonlinear activation function of the Lth layer. It can be seen that the weight matrix w^{L} of the Encoder layer and the Decoder layer may be implemented through parameter self-learning; that is, the filter may be automatically generated by learning during the training process through gradient back propagation; a low-level feature is firstly generated, and then a high-level feature is combined from the low-level feature.

According to the time-domain loss function, the weight matrix N(α) of the time-domain convolution kernel and the weight matrix w^{L} of the neural network are trained by using an error back propagation algorithm. For example, the training process of the neural network model may adopt a BP (Error Back Propagation) algorithm; by randomly initializing the parameters, the parameters can be continuously updated along with the deepening of the training. For example, the output of the output layer can be obtained by sequentially calculating from front to back according to the original input; the difference between the current output and the target output can be calculated, that is, to calculate the time-domain loss function; the time-domain loss function can be minimized by using a gradient descent algorithm, an Adam optimization algorithm, or the like, to sequentially update the parameters from back to front, that is, to sequentially update the weight matrix N(α) of the time-domain convolution kernel and the weight matrix w^{L} of the neural network.

Among them, the error pack propagation process may be that the j th weight value is the j−1th weight minus a learning rate and an error gradient, that is:

$${α}_{j} = {α}_{j - 1} - λ \frac{\partial E ( {α}_{j - 1} )}{\partial {α}_{j - 1}} = {α}_{j - 1} - λ \frac{\partial E}{\partial I} \frac{\partial I}{\partial {α}_{j - 1}} ,$$

where, λ is the learning rate; ∂E is an error pack propagated to the TRAL by the U-Net convolutional neural network; ∂E(αⱼ₋₁)/∂αⱼ₋₁ is the error gradient pack propagated to the TRAL by the U-Net convolutional neural network; and, according to the following:

$$\frac{\partial E}{\partial I} = {( {w}^{1} )}^{T} * {( {g}^{1} )}^{′} * {( {w}^{2} )}^{T} * {( {g}^{2} )}^{′} … {( {w}^{L} )}^{T} * {( {g}^{L} )}^{′}$$

$$\frac{\partial I}{\partial {α}_{j - 1}} = - {α}_{j - 1}^{D - 1} {I}_{i} ( n ) - {\sum }_{i = 1}^{D - 1} {α}_{j - 1}^{D - i} {I}_{i} ( n ) ,$$

the smoothing factor matrix α=[a₀ . . . α_{N}] can be updated. In some embodiments, the initial weight w₀^{L} of the deep neural network may be set first, the ith sample speech signal is used as a reference signal, and a noise signal is added to construct a corresponding ith original speech signal; according to the ith original speech signal, the corresponding ith first feature is obtained through forward calculation by the deep neural network; according to the ith first feature and the ith sample speech signal, a mean square error is calculated and an ith mean square error is obtained; the ith sample speech signal is squared, averaged, and is made a ratio to the obtained ith mean square error, so as to obtain an optimal weight coefficient w^{L} of each layer after training; The output value of the deep neural network may be calculated according to the optimal weight coefficient.

In step S530, the enhanced speech signal is obtained by performing combined feature extraction on the speech signal to be enhanced according to the weight matrix obtained by training.

The original speech signal can be input into the TRAL module, and the original speech signal and the output of the TRAL module can be combined and input into the U-NET convolutional neural network model; after each weight factor is trained, combined feature extraction can be performed on the original input and the output of the TRAL module.

Referring to FIG. 6, combined feature extraction may be implemented according to steps S610 to S630.

In step S610, a first time-domain feature map is obtained by performing a convolution operation on the weight matrix obtained by training and an original speech signal in the speech signal to be enhanced.

The original speech signal may be used as an input of a deep neural network. The original speech signal may be a 1*N one-dimensional vector. The first time-domain feature map may be obtained by performing a convolution operation on the one-dimensional vector and the weight matrix \vec{w}₀ obtained by training.

In step S620, a second time-domain feature map is obtained by performing a convolution operation on the weight matrix obtained by training and the smoothing feature in the speech signal to be enhanced.

The smoothing feature may be used as an input of the deep neural network to perform a convolution operation on the smoothing feature and the weight matrix obtained by training, so as to obtain the second time-domain feature map.

In step S630, the enhanced speech signal is obtained by combining the first time-domain feature map and the second time-domain feature map.

In this example, the time-domain signal smoothing algorithm is taken as an one-dimensional TRAL module, and can be successfully incorporated into the deep neural network model, and can be ideally combined with the convolutional neural network, the recurrent neural network and the fully connected neural network to realize gradient propagation, so that convolution kernel parameters in the TRAL module, namely the parameters of the noise reduction algorithm, can be driven by data, and optimal weight coefficient in statistical significance can be obtained without expert knowledge as prior information. In addition, when predicting the pure speech signal by directly performing speech enhancement on the time-domain speech signal with a noise, the amplitude information and the phase information in the time-domain speech signal can be used, and the method for speech enhancement is more practical with a better speech enhancement effect.

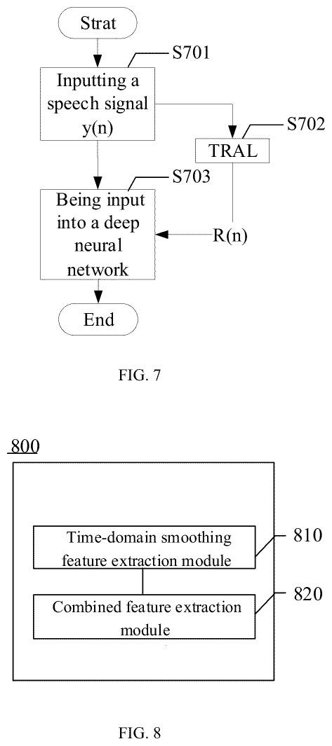

FIG. 7 schematically shows a flowchart of speech enhancement combining a TRAL module with a deep neural network. The process may include steps S701 to S703.

In step S701, a speech signal y(n) is input, the signal being a speech signal with a noise, including a pure speech signal and a noise signal.

In step S702, the speech signal with a noise is input into a TRAL module, and time-domain smoothing feature extraction is performed on the phase information and the amplitude information of the speech signal with a noise, so as to obtain a speech signal R(n) after noise reduction along the time axis.

In step S703, it is input into the deep neural network. The speech signal with a noise y(n) and the speech signal R(n) after noise reduction along the time axis are input into the deep neural network to perform combined feature extraction, so as to obtain an enhanced speech signal.

In this example, a time-domain signal smoothing algorithm is incorporated into an end-to-end (i.e. sequence-to-sequence) speech enhancement task, and the algorithm is made into a one-dimensional convolution module, that is, a TRAL module, which is equivalent to that a filter including expert knowledge is added. The signal-to-noise ratio of the original input information can be improved, the input information of the deep neural network can be increased, and then the speech enhancement evaluation index, such as PESQ (Percept Evaluation of Speech Quality), STOI (Short-Time Objective Intelligibility), FW SNR (Frequency Weighted Signal-to-Noise Ratio), or the like, can be improved. In addition, the TRAL module and the deep neural network can be connected through gradient back propagation, so that self-learning of the noise reduction parameter can be realized, and then an optimal parameter of statistical significance can be obtained. The process does not need to manually design an operator or need expert knowledge as a priori. That is, the TRAL module not only incorporates expert knowledge in the field of signal processing, but also performs parameter optimization in combination with a gradient back propagation algorithm of a deep neural network, the advantages of both of which are fused, thus improving the final speech enhancement effect.

In the method for speech enhancement provided by the embodiment of the present disclosure, a time-domain smoothing feature of the original speech signal is obtained by performing feature extraction on the original speech signal using the time-domain convolution kernel; and, an enhanced speech signal is obtained by performing combined feature extraction on the original speech signal and the time-domain smoothing feature of the original speech signal. On one hand, by performing enhancement on both the amplitude information and the phase information in the original speech signal, the overall effect of speech enhancement can be improved; on the other hand, the time-domain smoothing feature extraction is performed on the original speech signal through the convolutional neural network, self-learning of the time-domain noise reduction parameter can be realized in combination with the deep neural network, and the quality of the speech signal can be further improved.

It should be noted that although the various steps of the methods in the present disclosure are described in a particular order in the drawings, this does not require or imply that these steps must be performed in the particular order, or that all of the illustrated steps must be performed to achieve the desired results. Additionally or alternatively, some steps may be omitted, a plurality of steps may be combined into one step for execution, and/or one step may be decomposed into multiple steps for execution, etc.

Furthermore, in some embodiments, there is further provided an apparatus for end-to-end speech enhancement based on a neural network, and the apparatus may be applied to a server or a terminal device. Referring to FIG. 8, the apparatus 800 for end-to-end speech enhancement may include a time-domain smoothing feature extraction module 810 and a combined feature extraction module 820, where:

The time-domain smoothing feature extraction module 810 is configured to obtain a time-domain smoothing feature of an original speech signal by performing feature extraction on the original speech signal using a time-domain convolution kernel.

The combined feature extraction module 820 is configured to obtain an enhanced speech signal by performing combined feature extraction on the original speech signal and the time-domain smoothing feature of the original speech signal.

In some embodiments, the time-domain smoothing feature extraction module 810 includes:
a parameter matrix determination unit, configured to determine a time-domain smoothing parameter matrix according to a convolution sliding window and a time-domain smoothing factor;
a weight matrix determination unit, configured to obtain a weight matrix of the time-domain convolution kernel by performing a product operation on the time-domain smoothing parameter matrix;
a time-domain operation unit, configured to obtain the time-domain smoothing feature of the original speech signal by performing a convolution operation on the weight matrix of the time-domain convolution kernel and the original speech signal.

In some embodiments, the parameter matrix determination unit includes:
a data initialization subunit, configured to initialize a plurality of time-domain smoothing factors;
a matrix determination subunit, configured to obtain the time-domain smoothing parameter matrix based on a preset convolution sliding window and the plurality of time-domain smoothing factors;

In some embodiments, the combined feature extraction module 820 includes:
an input signal obtaining unit, configured to obtain a speech signal to be enhanced by combining the original speech signal and the time-domain smoothing feature of the original speech signal;
a weight matrix training unit, configured to train a weight matrix of the time-domain convolution kernel by using a back propagation algorithm with the speech signal to be enhanced as an input of a deep neural network;
an enhanced speech signal obtaining unit, configured to obtain the enhanced speech signal by performing combined feature extraction on the speech signal to be enhanced according to the weight matrix obtained by training.

In some embodiments, the weight matrix training unit includes:
a data input subunit, configured to input the speech signal to be enhanced into a deep neural network, and construct a time-domain loss function;
a data training subunit, configured to train the weight matrix of the time-domain convolution kernel by using an error back propagation algorithm according to the time-domain loss function.

In some embodiments, the enhanced speech signal obtaining unit includes:
a first feature map obtaining subunit, configured to obtain a first time-domain feature map by performing a convolution operation on the weight matrix obtained by training and an original speech signal in the speech signal to be enhanced;
a second feature map obtaining subunit, configured to obtain a second time-domain feature map by performing a convolution operation on the weight matrix obtained by training and a smoothing feature in the speech signal to be enhanced;
a feature combination subunit, configured to obtain the enhanced speech signal by combining the first time-domain feature map and the second time-domain feature map.

The specific details of each module in the apparatus for end-to-end speech enhancement have been described in detail in the corresponding method for speech enhancement, and therefore, details are not described here again.

It should be noted that although several modules or units of a device for action execution are mentioned in the above detailed description, such partitioning is not mandatory. Indeed, according to embodiments of the present disclosure, the features and functions of the two or more modules or units described above may be embodied in one module or unit for concretization. Conversely, the features and functions of one module or unit described above may be further divided into a plurality of modules or units for concretization.

It should be understood that the present disclosure is not limited to the exact construction that has been described above and illustrated in the accompanying drawings, and that various modifications and changes may be made without departing from the scope of the present disclosure. The scope of the present disclosure is limited only by the appended claims.

1. A method for end-to-end speech enhancement based on a neural network, comprising:
obtaining, by a server or a terminal device, a time-domain smoothing feature of an original speech signal by performing feature extraction on the original speech signal using a time-domain convolution kernel; and
obtaining, by the server or the terminal device, an enhanced speech signal by performing combined feature extraction on the original speech signal and the time-domain smoothing feature of the original speech signal.

2. The method for end-to-end speech enhancement according to claim 1, wherein obtaining a time-domain smoothing feature of an original speech signal by performing feature extraction on the original speech signal using a time-domain convolution kernel comprises:
determining a time-domain smoothing parameter matrix according to a convolution sliding window and a time-domain smoothing factor:
obtaining a weight matrix of the time-domain convolution kernel by performing a product operation on the time-domain smoothing parameter matrix; and
obtaining the time-domain smoothing feature of the original speech signal by performing a convolution operation on the weight matrix of the time-domain convolution kernel and the original speech signal.

3. The method for end-to-end speech enhancement according to claim 2, wherein determining a time-domain smoothing parameter matrix according to a convolution sliding window and a time-domain smoothing factor comprises:
initializing a plurality of time-domain smoothing factors; and
obtaining the time-domain smoothing parameter matrix based on a preset convolution sliding window and the plurality of time-domain smoothing factors.

4. The method for end-to-end speech enhancement according to claim 1, wherein obtaining an enhanced speech signal by performing combined feature extraction on the original speech signal and the time-domain smoothing feature of the original speech signal comprises:
obtaining a speech signal to be enhanced by combining the original speech signal and the time-domain smoothing feature of the original speech signal;
training a weight matrix of the time-domain convolution kernel by using a back propagation algorithm with the speech signal to be enhanced as an input of a deep neural network, and;
obtaining the enhanced speech signal by performing combined feature extraction on the speech signal to be enhanced according to the weight matrix obtained by training.

5. The method for end-to-end speech enhancement according to claim 4, wherein training a weight matrix of the time-domain convolution kernel by using a back propagation algorithm with the speech signal to be enhanced as an input of a deep neural network comprises:
inputting the speech signal to be enhanced into the deep neural network, and constructing a time-domain loss function; and
training the weight matrix of the time-domain convolution kernel by using an error back propagation algorithm according to the time-domain loss function.

6. The method for end-to-end speech enhancement according to claim 4, wherein obtaining the enhanced speech signal by performing combined feature extraction on the speech signal to be enhanced according to the weight matrix obtained by training comprises:
obtaining a first time-domain feature map by performing a convolution operation on the weight matrix obtained by training and an original speech signal in the speech signal to be enhanced;
obtaining a second time-domain feature map by performing a convolution operation on the weight matrix obtained by training and a smoothing feature in the speech signal to be enhanced; and
obtaining the enhanced speech signal by combining the first time-domain feature map and the second time-domain feature map.

7. (canceled)

8. (canceled)

9. (canceled)

10. (canceled)

11. (canceled)

12. (canceled)

13. A computer-readable storage medium, with a computer program stored thereon: wherein, when the computer program is executed by a processor, a method for end-to-end speech enhancement based on a neural network is implemented, and the method comprises:
obtaining a time-domain smoothing feature of an original speech signal by performing feature extraction on the original speech signal using a time-domain convolution kernel; and
obtaining an enhanced speech signal by performing combined feature extraction on the original speech signal and the time-domain smoothing feature of the original speech signal.

14. An electronic device, comprising:
a processor; and
a memory, configured to store an executable instruction of the processor;
wherein the processor is configured to execute a method for end-to-end speech enhancement based on a neural network by executing the executable instruction, and the method comprises:
obtaining a time-domain smoothing feature of an original speech signal by performing feature extraction on the original speech signal using a time-domain convolution kernel; and
obtaining an enhanced speech signal by performing combined feature extraction on the original speech signal and the time-domain smoothing feature of the original speech signal.

15. The method for end-to-end speech enhancement according to claim 1, wherein obtaining a time-domain smoothing feature of an original speech signal by performing feature extraction on the original speech signal using a time-domain convolution kernel comprises:
performing speech enhancement on phase information and amplitude information in the original speech signal by inputting the original speech signal into a deep neural network for time-varying feature extraction.

16. The method for end-to-end speech enhancement according to claim 1, wherein the original speech signal is represented by a one-dimensional vector.

17. The computer-readable storage medium according to claim 13, wherein obtaining a time-domain smoothing feature of an original speech signal by performing feature extraction on the original speech signal using a time-domain convolution kernel comprises:
determining a time-domain smoothing parameter matrix according to a convolution sliding window and a time-domain smoothing factor;
obtaining a weight matrix of the time-domain convolution kernel by performing a product operation on the time-domain smoothing parameter matrix; and
obtaining the time-domain smoothing feature of the original speech signal by performing a convolution operation on the weight matrix of the time-domain convolution kernel and the original speech signal.

18. The computer-readable storage medium according to claim 17, wherein determining a time-domain smoothing parameter matrix according to a convolution sliding window and a time-domain smoothing factor comprises:
initializing a plurality of time-domain smoothing factors; and
obtaining the time-domain smoothing parameter matrix based on a preset convolution sliding window and the plurality of time-domain smoothing factors.

19. The computer-readable storage medium according to claim 13, wherein obtaining an enhanced speech signal by performing combined feature extraction on the original speech signal and the time-domain smoothing feature of the original speech signal comprises:
obtaining a speech signal to be enhanced by combining the original speech signal and the time-domain smoothing feature of the original speech signal;
training a weight matrix of the time-domain convolution kernel by using a back propagation algorithm with the speech signal to be enhanced as an input of a deep neural network, and;
obtaining the enhanced speech signal by performing combined feature extraction on the speech signal to be enhanced according to the weight matrix obtained by training.

20. The computer-readable storage medium according to claim 19, wherein training a weight matrix of the time-domain convolution kernel by using a back propagation algorithm with the speech signal to be enhanced as an input of a deep neural network comprises:
inputting the speech signal to be enhanced into the deep neural network, and constructing a time-domain loss function; and
training the weight matrix of the time-domain convolution kernel by using an error back propagation algorithm according to the time-domain loss function.

21. The computer-readable storage medium according to claim 19, wherein obtaining the enhanced speech signal by performing combined feature extraction on the speech signal to be enhanced according to the weight matrix obtained by training comprises:
obtaining a first time-domain feature map by performing a convolution operation on the weight matrix obtained by training and an original speech signal in the speech signal to be enhanced;
obtaining a second time-domain feature map by performing a convolution operation on the weight matrix obtained by training and a smoothing feature in the speech signal to be enhanced; and
obtaining the enhanced speech signal by combining the first time-domain feature map and the second time-domain feature map.

22. The electronic device according to claim 14, wherein obtaining a time-domain smoothing feature of an original speech signal by performing feature extraction on the original speech signal using a time-domain convolution kernel comprises:
determining a time-domain smoothing parameter matrix according to a convolution sliding window and a time-domain smoothing factor;
obtaining a weight matrix of the time-domain convolution kernel by performing a product operation on the time-domain smoothing parameter matrix; and
obtaining the time-domain smoothing feature of the original speech signal by performing a convolution operation on the weight matrix of the time-domain convolution kernel and the original speech signal.

23. The electronic device according to claim 22 wherein determining a time-domain smoothing parameter matrix according to a convolution sliding window and a time-domain smoothing factor comprises:
initializing a plurality of time-domain smoothing factors; and
obtaining the time-domain smoothing parameter matrix based on a preset convolution sliding window and the plurality of time-domain smoothing factors.

24. The electronic device according to claim 14, wherein obtaining an enhanced speech signal by performing combined feature extraction on the original speech signal and the time-domain smoothing feature of the original speech signal comprises:
obtaining a speech signal to be enhanced by combining the original speech signal and the time-domain smoothing feature of the original speech signal;
training a weight matrix of the time-domain convolution kernel by using a back propagation algorithm with the speech signal to be enhanced as an input of a deep neural network, and;
obtaining the enhanced speech signal by performing combined feature extraction on the speech signal to be enhanced according to the weight matrix obtained by training.

25. The electronic device according to claim 24, wherein training a weight matrix of the time-domain convolution kernel by using a back propagation algorithm with the speech signal to be enhanced as an input of a deep neural network comprises:
inputting the speech signal to be enhanced into the deep neural network, and constructing a time-domain loss function; and
training the weight matrix of the time-domain convolution kernel by using an error back propagation algorithm according to the time-domain loss function.

26. The electronic device according to claim 24, wherein obtaining the enhanced speech signal by performing combined feature extraction on the speech signal to be enhanced according to the weight matrix obtained by training comprises:
obtaining a first time-domain feature map by performing a convolution operation on the weight matrix obtained by training and an original speech signal in the speech signal to be enhanced;
obtaining a second time-domain feature map by performing a convolution operation on the weight matrix obtained by training and a smoothing feature in the speech signal to be enhanced; and
obtaining the enhanced speech signal by combining the first time-domain feature map and the second time-domain feature map.
